(19) United States
(12) Patent Application Publication
(10) Pub. No.: US 2026/0104854 A1
(43) Pub. Date: Apr. 16, 2026

(54) DIMENSIONAL COMBINATION

(71) Applicant: Arm Limited, Cambridge (GB)

(72) Inventors: Rune HOLM, Oslo (NO); Dominic Hugo SYMES, Cambridge (GB)

(21) Appl. No.: 18/916,271

(22) Filed: Oct. 15, 2024

(51) Int. Cl. G06F 7/14

(52) U.S. Cl. CPC G06F 7/14

(57) ABSTRACT

A processor comprising storage, execution circuitry and a handling unit. The handling unit is configured to obtain operation data indicative of an operation to be executed using the execution circuitry. The execution circuitry is configured to operate over a multi-dimensional nested loop defining an operation space. The handling unit obtains a dimensional combination instruction and, in response, combines a plurality of dimensions of the operation space to obtain a local space dimension in an operation-specific local space as part of a procedure to map each operation block of a plurality of operation blocks in the operation space to a different respective local block in the local space dimension. The handling unit dispatches invocation data for the plurality of operation blocks to the execution circuitry. The invocation data for each respective operation block specifies a local space dimension range of a local block to be operated on for the respective operation block.

### BACKGROUND

### Technical Field

The disclosure herein relates to processors and data processing instructions.

### Description of the Related Technology

Certain data processing techniques, such as neural network processing and graphics processing, involve the processing and generation of considerable amounts of data using operations. It is desirable to efficiently handle data such as this.

### SUMMARY

According to a first aspect of the present disclosure, there is provided a processor comprising storage, execution circuitry and a handling unit, the handling unit configured to: obtain operation data indicative of an operation to be executed using the execution circuitry, wherein the execution circuitry is configured to operate over a multi-dimensional nested loop defining an operation space; obtain a dimensional combination instruction; in response to the dimensional combination instruction, combine a plurality of dimensions of the operation space to obtain a local space dimension in an operation-specific local space as part of a procedure to map each operation block of a plurality of operation blocks in the operation space to a different respective local block in the local space dimension; and dispatch invocation data for the plurality of operation blocks to the execution circuitry, wherein the invocation data for each respective operation block specifies a local space dimension range of a local block to be operated on for the respective operation block.

According to a second aspect of the present disclosure, there is provided a computer program for controlling a host data processing apparatus to provide an instruction execution environment for execution of target program code, the computer program comprising: data structure program logic for interacting with a data structure; and processing program logic configured to: obtain operation data indicative of an operation to be executed using the execution circuitry, the instruction execution environment configured to operate over a multi-dimensional nested loop defining an operation space; obtain a dimensional combination instruction; in response to the dimensional combination instruction, combine a plurality of dimensions of the operation space to obtain a local space dimension in an operation-specific local space as part of a procedure to map each operation block of a plurality of operation blocks in the operation space to a different respective local block in the local space dimension; and provide invocation data for the plurality of operation blocks to the data structure program logic, wherein the invocation data for each respective operation block specifies a local space dimension range of a local block to be operated on for the respective operation block.

According to a third aspect of the present disclosure, there is provided a method of performing a dimensional combination instruction, the method comprising: obtaining, by handling circuitry, operation data indicative of an operation to be executed using processing circuitry, wherein the processing circuitry is configured to operate over a multi-dimensional nested loop defining an operation space; obtaining, by the handling circuitry, the dimensional combination instruction; in response to the dimensional combination instruction, the handling circuitry combining a plurality of dimensions of the operation space to obtain a local space dimension in an operation-specific local space, such that each operation block of a plurality of operation blocks in the operation space is mapped to a different respective local block in the local space dimension.

### BRIEF DESCRIPTION OF THE DRAWINGS

FIG. 1 is a flow diagram of a method of performing a dimensional combination instruction according to an example;

FIG. 2 is a schematic representation of an example apparatus;

FIG. 3 is a schematic diagram illustrating performance of a dimensional combination instruction according to an example;

FIG. 4 illustrates an example directed graph;

FIG. 5 is a schematic diagram of a data processing system;

FIG. 6 is a schematic diagram of an example neural engine;

FIG. 7 is a schematic diagram of an example system for allocating handling data;

FIG. 8 is a schematic representation of a simulator implementation according to an example; and

FIG. 9 is a schematic diagram of manufacture of a system and a chip-containing product.

### DETAILED DESCRIPTION

### Dimensional Combination Instruction

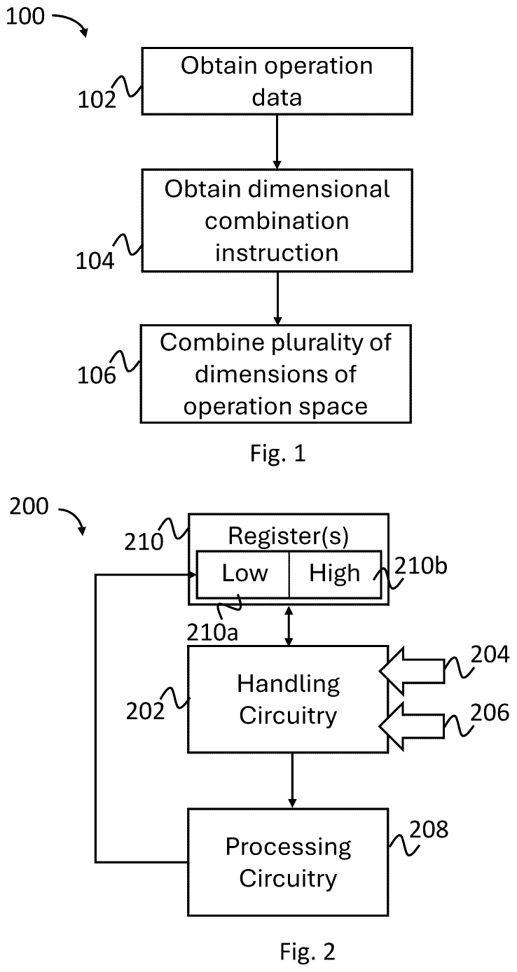

FIG. 1 is a flow diagram 100 showing a method of performing a dimensional combination instruction. The method may be performed by a handling unit of a processor comprising execution circuitry. The handling unit may be implemented by handling circuitry so that the method is executed by the handling circuitry. The execution circuitry may be considered to be an example of processing circuitry.

At item 102 of the flow diagram 100, operation data is obtained. The operation data is indicative of an operation to be executed, for example by processing circuitry such as the execution circuitry of the processor. In examples such as that of FIG. 1, the execution circuitry is configured to operate over a multi-dimensional nested loop defining an operation space. At item 104, a dimensional combination instruction is obtained. At item 106, a plurality of dimensions of the operation space are combined, in response to the dimensional combination instruction, to obtain a local space dimension in an operation-specific local space as part of a procedure to map each operation block of a plurality of operation blocks in the operation space to a different respective local block in the local space dimension.

The dimensional combination instruction may be considered to instruct the combination of the plurality of dimensions in the operation space to obtain a lower-dimensional operation-specific local space. By combining the plurality of dimensions of the operation space, a dimensionality of the operation-specific local space is reduced compared to a dimensionality of the operation space. Each operation block therefore occupies a larger number of dimensions within the operation space than a number of dimensions occupied by the local block within the operation-specific local space. Combining the plurality of dimensions of the operation space in this manner for example maps or otherwise transforms higher-dimensional operation blocks in the operation space to lower-dimensional local blocks in the operation-specific local space. For example, an operation block may correspond to a multi-dimensional coordinate range in the operation space, which is mapped to a coordinate range in the operation-specific local space in the local space dimension in response to the dimensional combination instruction.

The dimensional combination instruction may allow for greater flexibility in the types of operation that are executable and may also or instead improve the efficiency with which particular operations can be executed. For example, data representing an extent of a dimension to be processed in executing an operation may be too large to be stored within particular storage, such as local storage of the processor configured to execute the operation. This may be the case for data intensive operations, such as those used for implementing a neural network. To address this, the dimension may be decomposed into a multi-dimensional nested loop so as to fit data representing at least one of the dimensions of the multi-dimensional nested loop into the storage at a given time. Dimensional decomposition such as this may involve dividing the dimension, which may be referred to as a decomposition dimension, into an outer dimension (corresponding to an outer loop of the multi-dimensional nested loop) and an inner dimension (corresponding to an inner loop of the multi-dimensional nested loop). Data representing an extent of the inner dimension may be sufficiently small to be stored within the storage, so that it can be re-used for each loop over the outer dimension without having to be fetched from further storage, e.g. external to the processor, for each loop over the outer dimension. In order to obtain the correct data to be processed for each iteration of the multi-dimensional nested loop, the outer and inner dimensions may be combined according to the dimensional combination instruction described herein in order to obtain the local space dimension in the operation-specific local space. In this way, operation blocks corresponding to respective iterations over the multi-dimensional nested loop may be mapped to local blocks in the local space dimension, so as to obtain local space dimension ranges of the local blocks to allow the correct portion of the data (corresponding to the correct local block) to be obtained from the storage. Data representing the inner dimension may remain in the storage and may be re-accessed for each iteration over the outer dimension, using the dimensional combination instruction to obtain the local space dimension range for a local block corresponding to a given operation block. This approach may reduce bandwidth and power consumption compared to retrieving the data representing the extent of the decomposition dimension from the further storage for each iteration over the decomposition dimension. The dimensional combination instruction facilitates decomposition of the decomposition dimension in this way, so that operations involving dimensional decomposition (and dimensional combination) can be performed.

A multi-dimensional nested loop utilizing dimensional combination according to an example is shown in the following pseudo-code:

```
for (n_outer = 0; n_outer < N; n_outer += n_outer_block_size) {
  for (n_inner = 0; n_inner < n_outer_block_size; n_inner += n_inner_block_size) {
    n = n_outer + n_inner;
    load(block_n, n, min(n_inner_block_size, N − n));
    // operate on block_n if not empty
  }
}
```

where n_outer and n_inner are loops over outer and inner dimensions of a multi-dimensional nested loop. The loop over the outer dimension is from 0 to N in increments of n_outer_block_size, the loop over the inner dimension is from 0 to n_outer_block_size in increments of n_inner_block_size, n represents the addition of the outer and inner dimensions and the load function indicates the loading of local block block_n with a local space dimension range obtained by combining the outer and inner dimensions of a corresponding operation block (where each operation block corresponds to a particular iteration over the multi-dimensional nested loop, i.e. a particular combination of increments in the outer and inner dimensions).

In this example, the operation space comprises two dimensions: an outer dimension and an inner dimension (n_outer and n_inner). The handling circuitry in this example is configured to perform the addition of an inner dimension block interval to an outer dimension block interval (e.g. corresponding to ranges of operation blocks in the inner and outer dimensions of the operation space, respectively) in response to the dimensional combination instruction of FIG. 1. This instruction instructs the addition of nested range intervals, and may be referred to as an ADDN instruction.

Although not shown in FIG. 1 it is to be appreciated that the method of FIG. 1 may further include dispatching invocation data for the plurality of operation blocks to the execution circuitry. The invocation data for example indicates the data that is to be processed in executing the operation. For example, the invocation data for each respective operation block may specify a local space dimension range of a local block to be operated on for the respective operation block.

FIG. 2 is a schematic representation of an apparatus 200 for performing a dimensional combination instruction as described above in relation to the flow diagram 100 of FIG. 1. The apparatus 200 has handling circuitry 202 configured to obtain operation data 204 and a dimensional combination instruction 206. The apparatus 200 further comprises processing circuitry 208 and a register 210. The apparatus may also comprise a storage medium (not shown), such as a solid-state drive (SSD) or other semiconductor-based RAM; a ROM, for example, a CD ROM or a semiconductor ROM; a magnetic recording medium, for example, a floppy disk or hard disk; optical memory devices in general; etc. In some examples, the register may form part of this storage medium.

The operation data 204 is indicative of an operation to be executed using the processing circuitry 208, which is configured to operate over a multi-dimensional nested loop defining an operation space as described with reference to FIG. 1. The handling circuitry 202 may be configured to receive various other data and/or instructions in addition to the operation data 204 and the dimensional combination instruction 206. Similarly, the processing circuitry 208 may be configured to perform any number of tasks, and in particular, is configured to perform at least dimensional combination in accordance with the dimensional combination instructions 206. As explained with reference to FIG. 1, in response to the dimensional combination instruction 206, the processing circuitry 208 combines the plurality of dimensions of the operation space to obtain the local space dimension in the operation-specific local space as part of a procedure to map each operation block of a plurality of operation blocks in the operation space to a different respective local block in the local space dimension.

In FIG. 2, the operation space is defined by data stored in registers 210, which in this example are boundary registers. The registers 210 comprise a respective register for each dimension of the dimensions of the multi-dimensional nested loop (including the plurality of dimensions that are to be combined in response to the dimensional combination instruction 206). For a particular operation block in the operation space, each register 210 comprises a low portion 210a storing a low bound of the operation block for the corresponding dimension, and a high portion 210b storing a high bound of the operation block for that dimension, prior to executing the dimensional combination instruction 206. The values stored in the low and high portions 210a, 210b of the register 210 for a given dimension thus define a range of the operation block in that dimension.

In FIG. 2, combining the plurality of dimensions comprises combining data stored in each of a plurality of the registers 210, such as first data stored in a first boundary register associated with the first dimension and second data stored in a second boundary register associated with the second dimension, to generate transformed data in at least one of the boundary registers 210. The transformed data defines a local block to which the particular operation block is mapped, based on the dimensional combination instruction 206.

For example, a range of a boundary register for dimension d may be represented by a low (b[d].lo) and a high (b[d].hi) signed component of the boundary register. In other words, the low and high portions 210a, 210b of each of the registers 210 of FIG. 2 may store the b[d].lo and b[d].hi values, respectively, for the corresponding dimension, d, in the operation space, prior to executing the dimensional combination instruction 206. Upon executing the dimensional combination instruction 206 to combine an outer and inner dimension of a multi-dimensional nested loop, which may be referred to as a first and second dimension respectively, the low and high bounds of the inner dimension may remain unchanged, but the low and high bounds of the outer dimension (i.e. the b[d].lo and b[d].hi values) may be updated. The low and high bounds of the outer dimension may be updated in response to the dimensional combination instruction 206 to represent the low and high bounds of a transformed, lower dimensional block in a local space dimension in the operation-specific local space, to which the first and second dimensions in the operation space are mapped. The updated low and high bounds of the outer dimension may be considered to correspond to the transformed data. In this example, the outer and inner dimensions together represent a two-dimensional operation space, whereas the local space dimension to which the outer and inner dimensions are mapped is a single dimension. In other examples, the values of a different register than that for the outer dimension, such as the register for the inner dimension, are updated in response to the dimensional combination instruction 206.

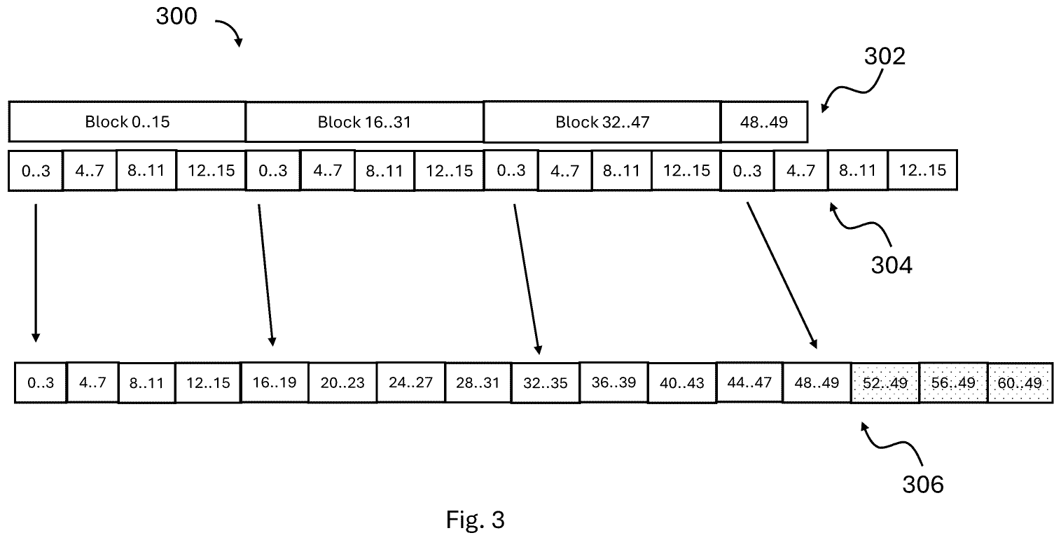

FIG. 3 shows schematically an example 300 of combining a first dimension 302 and a second dimension 304 of a multi-dimensional nested loop defining an operation space to obtain a local space dimension 306 in an operation-specific local space, e.g. in response to a dimensional combination instruction as described with reference to FIGS. 1 and 2. In FIG. 3, a loop in a single dimension over values from 0 to 49 in increments of 1 is decomposed into the first and second dimensions 302, 304 so as to obtain the multi-dimensional nested loop. The first dimension 302, corresponding to a first loop of the multi-dimensional nested loop, corresponds to steps from 0 to 49 in increments of 16. The second dimension 304, which corresponds to a second loop of the multi-dimensional nested loop, inwards of the first loop, corresponds to steps from 0 to 15 in increments of 4. A first increment in each of the first and second dimensions 302, 304 (i.e. block 0 . . . 15 in the first dimension 302 and block 0 . . . 3 in the second dimension 304) corresponds to a first (two-dimensional) operation block in the operation space. Each operation block is formed of a respective block in each of the dimensions of the operation space, so that the first operation block comprises first blocks in the first and second dimensions 302, 304 (blocks 0 . . . 15 and 0 . . . 3) for the first increment in each of these dimensions. A first increment in the first dimension 302 and second, third and fourth increments in the second dimension 304 (i.e. the first block, block 0 . . . 15, in the first dimension 302 and second to fourth blocks, blocks 4 . . . 7, 8 . . . 11 and 12 . . . 15, respectively, in the second dimension 304) correspond to second to fourth operation blocks in the operation space, respectively. A second increment in the first dimension 304 and first to fourth increments in the second dimension 304 (i.e. second block, block 16 . . . 31, in the first dimension 302 and first to fourth blocks, blocks 0 . . . 3, 4 . . . 7, 8 . . . 11 and 12 . . . 15, respectively, in the second dimension 304) correspond to fifth to seventh operation blocks in the operation space, respectively, and so on. In this way, there are fifteen operation blocks in the operation space. FIG. 3 shows a plurality of operation blocks comprising a plurality of sets of operation blocks, each corresponding to a different iteration of the first loop in the first dimension 302 (i.e. a different increment in the first dimension 302, corresponding to a different block in the first dimension 302). For each respective set of the plurality of sets of operation blocks, each operation block of the respective set corresponds to a different iteration of the second loop in the second dimension 304 (i.e. a different increment in the second dimension 304, corresponding to a different block in the second dimension 304).

In FIG. 3, a handling unit of a processor comprising storage and execution circuitry to execute the operation determines the ranges of the operation blocks, based on the operation data. In this example, the handling unit determines first and second logical block sizes, for the first and second dimensions 302, 304, based on the operation data. The first and second logical block sizes each correspond to first and second physical block sizes. In the example of FIG. 3, the first physical block size is 16 and the second physical block size is 4. The handling unit divides the first dimension 302 into a first set of one-dimensional blocks (the blocks 0 . . . 15, 16 . . . 31, 32 . . . 47 and 48 . . . 49 of the first dimension 302 in FIG. 3) and the second dimension 304 into a second set of one-dimensional blocks (the blocks 0 . . . 3, 4 . . . 7, 8 . . . 11 and 12 . . . 15 of the second dimension 304 in FIG. 3) based on the first and second logical block sizes, respectively. In this example, the data to be operated on spans a range of 0 to 49 in the first dimension 302, which is not a multiple of the first logical block size. The first dimension 302 in this case divided into one-dimensional blocks which each have the first logical block size, except for the final block (block 48 . . . 49), which has a size of less than the first logical block size. Dividing the first dimension 302 in this manner optimizes the number of one-dimensional blocks of the first dimension 302 with the first logical block size, which can simplify handling of the one-dimensional blocks, e.g. if the processor is configured to operate on blocks with the first logical block size, as discussed further below. The data to be operated on spans a range of 0 to 15 in the second dimension 304, which is a multiple of the second logical block size, allowing the second dimension 304 to be divided exactly into one-dimensional blocks each having the same size (the second logical block size), although this need not be the case in other examples.

A size of the storage of the processor may be less than n times the first physical block size and greater than or equal to n times the second physical block size, where n is an integer with a value greater than or equal to 2. This means that n one-dimensional blocks with the first physical block size in the first dimension 302 are too large to be stored in the storage. However, the storage is sufficiently large to store at least n one-dimensional blocks with the second physical block size in the second dimension 304, allowing a plurality of the second set of one-dimensional blocks to be stored in the storage at the same time. These blocks can be retained in storage and re-used, which can reduce bandwidth for executing the operation. For example, the storage may be local storage of the processor, which can be accessed more rapidly than storage external to the processor.

The handling unit for example determines the first and second logical block sizes to optimize usage of the storage, for example to optimize re-use of data stored therein to reduce fetching of data from further storage. In FIG. 3, the storage has sufficient storage capacity to store all four of the one-dimensional blocks in the second dimension 304 at the same time. Each of these blocks (the blocks 0 . . . 3, 4 . . . 7, 8 . . . 11 and 12 . . . 15 of the second dimension 304 in FIG. 3) is thus fetched once, prior to executing the operation, and retained in storage as the first dimension 302 is iterated over. Each of these blocks of the second dimension 304 is re-used for each iteration of the first dimension 302, without being re-fetched from further storage.

In examples such as FIG. 3, each block of the first set of one-dimensional blocks corresponds to a respective iteration of the first loop, each block of the second set of one-dimensional blocks corresponds to a respective iteration of the second loop, and an iteration of the first loop comprises m iterations of the second loop, where m is an integer. In these examples, the size of the storage may be less than m times the first physical block size and greater than or equal to m times the second physical block size. In FIG. 3, m is equal to four, as there are four iterations of the second loop (in the second dimension 304) per iteration of the first loop (in the first dimension 302). Each iteration of the second loop comprises processing of a one-dimensional block of the second set of one-dimensional blocks with a block size of four. This is merely an example, though, and in other examples there may be different mappings between loop iterations and blocks.

In FIG. 3, combining the plurality of dimensions (in this case, the first and second dimensions 302, 304) comprises, for a particular operation block, combining sets of operation block range data, each indicative of a range, in a respective dimension of the plurality of dimensions, of the particular operation block. For example, for the first increment in the first dimension 302 (block 0 . . . 15 in FIG. 3), the operation block range data indicates the range 0 to 15 in the first dimension 302, and for the second increment in the first dimension 302 (block 16 . . . 31 in FIG. 3), the operation block range data indicates the range 16 to 31 in the first dimension 302, and so forth. The range may be taken as indicating a range of coordinates occupied by the operation block within a given dimension in the operation space, and in this example includes low and high bounds of the operation block in the given dimension. In other words, a first set of operation block range data for the first dimension 302 represents at least a first low bound and a first high bound of the particular operation block in the first dimension 302 and a second set of operation block range data for the second dimension 304 represents at least a second low bound and a second high bound of the particular operation block in the second dimension 304.

Combining the sets of operation block range data generates local block range data indicative of the local space dimension range of the local block to which the particular operation block is mapped. The local block range data in FIG. 3 is similar to that for the first and second dimensions but for the local space dimension, and represents a low bound and a high bound of the local block in the local space dimension. Each operation block may be mapped to a different respective local block. Each local block may be non-overlapping with each other.

The first and second dimensions 302, 304 may be combined, mapped or otherwise transformed in various ways to obtain the local space dimension. For example, a low bound of a local block may be based on a combination of the first low bound and the second low bound and/or the high bound of the local block may be based on the first high bound, the second high bound and at least one of the first low bound and the second low bound.

Hardware, such as the processor and/or circuitry thereof, may be configured to operate on data blocks of a particular size, such as blocks of 16 elements. However, it may be desirable for the hardware to be compatible with blocks of different sizes to provide more flexibility at the software level, for example to allow software to output blocks with a size that is not a multiple of 16. In order to provide this compatibility, generating the local block range data may comprise clipping the range of the local block based on at least one of the sets of operation block range data. This provides a way for the handling circuitry to handle operation blocks with a size that differs from a particular block size the execution circuitry is configured to operate on.

For example, if the first high bound is higher than the second high bound, the clipping may comprise clipping the high bound of the local block to the first high bound. The range of the local block may be clipped to avoid exceeding a predefined set of values to be looped over. For example, if a number of values in the predefined set of values is not a multiple of the particular block size the execution circuitry is configured to operate on, execution of the operation on the predefined set of values may finish in the processing of a final operation block with a size that differs from the particular block size.

In FIG. 3, the execution circuitry is configured to operate on blocks of 16 elements, i.e. with a size of 16. In this example, the operation is initially defined as a loop over a set of values from 0 to 49. As there are 50 values in the set of values to be looped over, which is not a multiple of 16, clipping is performed to avoid executing loops from values of 50 upwards. This approach thus provides the flexibility to perform the operation on sets of values of various sizes, which need not be a multiple of the size of block the execution circuitry is configured to operate on. In such cases, in response to the first high bound being smaller than a combination of the second high bound and the first low bound, the high bound of the local block may be taken as the first high bound and, in response to the first high bound being greater than or equal to a combination of the second high bound and the first low bound, the high bound of the local block may be taken as the combination of the second high bound and the first low bound.

In the example of FIG. 3, the low bound of the local block is a sum of the first low bound and the second low bound, and the high bound of the local block is a minimum of: the first high bound, and a sum of the second high bound and the first low bound. The generation of the local block range data in this manner may be expressed using the following pseudo-code:

```
/* Add nested interval b[src1] to b[d] */
execute(bound_t b[NUM_B], uint3_t &dst, bound_t &acc, bool &end_flag) {
    outer_lo = b[d].lo;
    outer_hi = b[d].hi;
    b[d].lo = outer_lo + b[src1].lo;
    b[d].hi = min(outer_lo + b[src1].hi, outer_hi);
  if (D) {
    dst = (dst + 1) % 8;
  }
}
```

where b represents a set of boundary registers, each storing a low and high bound for a respective dimension of a multi-dimensional nested loop, outer_lo and outer_hi represent the low and high bounds of the operation block in the first dimension 302, d is the current destination register of the set of boundary registers (which is the register to be updated, and corresponds to a particular dimension), src1 is the source register of the set of boundary registers (which stores the low and high bounds of the operation block in the second dimension 304, b[src1].lo and b[src1].hi). The current destination register d initially stores the low and high bounds of the operation block in the first dimension 302 (assigned to parameters outer_lo and outer_hi in the pseudo-code), but the values stored in the current destination register d (b[d].lo and b[d].hi) are subsequently updated to reflect the calculated low and high bounds of the local block in the local space dimension 306 in FIG. 3. Hence, for the local block corresponding to the first operation block (i.e. corresponding to the first increments in the first and second dimensions 302, 304), the low bound is the sum of the low bounds of the first operation block in the first and second dimensions 302, 304 (i.e. 0+0, which equals 0), and the high bound is the minimum of the high bound of the first operation block in the first dimension 302 (i.e. 15) and a sum of the low bound of the first operation block in the first dimension 302 and the high bound of the first operation block in the second dimension 304 (i.e. 0+3, which equals 3), i.e. the high bound is 3.

In this example, the high bound of each local block is equal to the sum of the low bound of the corresponding operation block in the first dimension 302 and the high bound of the corresponding operation block in the second dimension 304 up until the final increment within the first dimension 302. In this example, the twelfth local block, corresponding to the final increment within the first dimension 302 (i.e. a fourth block, block 48 . . . 49, in the first dimension 302) and the first increment in the second dimension 304 (i.e. a first block, block 0 . . . 3, in the second dimension 304) has a low bound of 0+48, i.e. 48 (the sum of the low bounds of the corresponding operation block in the first and second dimensions 302, 304). A high bound of this local block is the minimum of the high bound of the corresponding operation block in the first dimension 302 (i.e. 49) and a sum of the low bound of the corresponding operation block in the first dimension 302 and the high bound of the corresponding operation block in the second dimension 304 (i.e. 48+3, which equals 51), i.e. the high bound is 49. This amounts to clipping the high bound of the local block so that the high bound of the local block does not exceed the high bound of the corresponding operation block in the first dimension 302.

In this example, clipping is applied to the high bound of the local block, without clipping the low bound of the local block. Due to this, the high bound of the local block may be lower than the low bound of the local block after clipping. This is the case for the thirteenth to fifteenth local blocks in FIG. 3, corresponding to the final increment within the first dimension 302 (i.e. block 48 . . . 49 in the first dimension 302) and the second to fourth increments in the second dimension 304 (i.e. the second to fourth blocks, blocks 4 . . . 7, 8 . . . 11, 12 . . . 15 respectively, in the second dimension 304) have low bounds of 52, 56 and 60 respectively (i.e. 4+48, 8+48, 12+48, calculated as the sum of the low bounds of the corresponding operation block in the first and second dimensions 302, 304). A high bound of these local blocks is the minimum of the high bound of the corresponding operation block in the first dimension 302 (i.e. 49 for each of these local blocks) and a sum of the low bound of the corresponding operation block in the first dimension 302 and the high bound of the corresponding operation block in the second dimension 304 (48+7, 48+11 and 48+15, respectively, i.e. 55, 59 and 63 respectively), i.e. the high bound is 49 for each of these local blocks. The local blocks to which clipping is applied are shown in FIG. 3 with dotted shading.

If the high bound is lower than the low bound for a given local block, the range of that local block, which may be referred to as an interval of the local block, may be considered empty. Invocation data may nevertheless still be generated for empty blocks, so as to dispatch empty blocks to execution circuitry, e.g. to a particular execution unit associated with execution of the operation. The execution circuitry may, however, be configured to detect that the blocks are empty and to signal to the handling circuitry that processing of the empty blocks is complete, in order with respect to other blocks (irrespective of whether those blocks are empty or not).

The invocation data generated by the handling unit may instruct execution of at least part of the operation by the execution circuitry. However, in response to the high bound of the local block being lower than the low bound of the local block, the handling unit in these examples is configured to generate the invocation data to indicate a physical storage location of the storage storing predefined data for the local block indicative that processing of the local block, in executing at least part of the operation, is to be omitted. The predefined data in these examples represents an empty block, which is dispatched to the execution circuitry by the handling unit and returned by the execution circuitry without the execution circuitry processing the local block in order to perform the at least part of the operation. For example, the execution circuitry may, based on the invocation data, obtain the predefined data from the physical storage location and, based on the predefined data, refrain from processing the local block in executing the at least part of the operation. The execution circuitry may for example identify that the local block is an empty block and that execution of the at least part of the operation does not involve processing of the local block. In other examples, though, the predefined data may not be an empty block and may instead indicate to the execution circuitry in a different manner that processing of the local block in executing the at least part of the operation is to be omitted.

### Execution of a Directed Graph

Many data structures to be executed in a processor can be expressed as a directed graph. Examples of such data structures include neural networks which can be represented as a directed graph of operations that wholly compose the operations required to execute a network (i.e. to execute the operations performed across the layers of a neural network). A directed graph of operations may comprise an operation for which a dimensional combination instruction may be performed as discussed above with reference to FIGS. 1 to 3. Examples involving a directed graph of operations will now be described.

A directed graph is a data structure of operations (which may be referred to herein as ‘sections’) having directed connections therebetween that indicate a flow of operations. The connections between operations (or sections) present in the graph of operations may be referred to as pipes (where a given connection is the sole tenant of a particular region of the storage unit, which region may be allocated to that connection statically or dynamically) or sub-pipes (where a given connection shares a particular region of the storage unit with at least one other connection). The allocation of particular storage elements within a given region of the storage unit to different respective sub-pipes that are tenants of the given region of the storage unit may be performed dynamically. A plurality of sub-pipes may belong to the same pipe as each other, which may be referred to as a multi-pipe. In such cases, the multi-pipe may be the sole tenant of the given region of the storage unit, which may itself be statically or dynamically allocated to the multi-pipe. A directed graph may contain any number of divergent and convergent branches. A directed graph may contain any number of divergent and convergent branches.

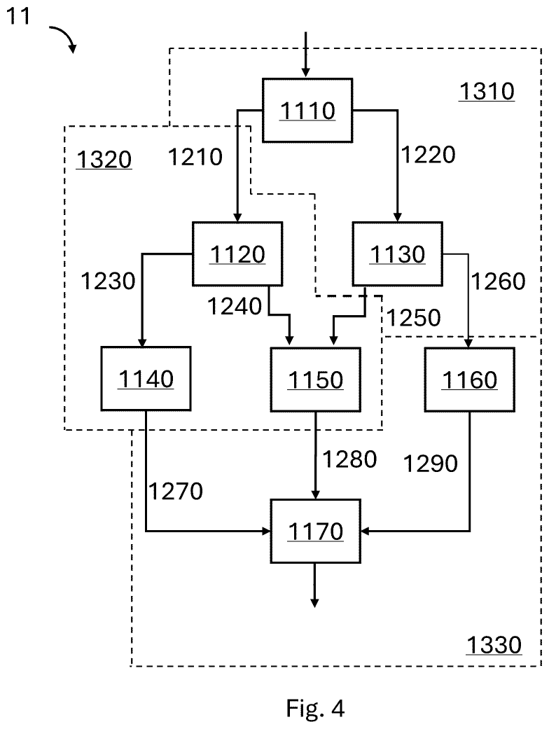

FIG. 4 illustrates an example directed graph 11 in which sections are interconnected by pipes or sub-pipes. Specifically, an initial section, section 1 (1110) represents a point in the directed graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the directed graph may receive multiple inputs, each from a respective different section in the directed graph via a respective different pipe or sub-pipe. In FIG. 4, sections 2 and 3 (1120, 1130) each write to different respective sub-pipes (1230, 1240, 1250, 1260) of the same pipe, pipe 3, which is a multi-pipe. Each sub-pipe has its own unique identifier, which also indicates the multi-pipe to which the sub-pipe belongs, where a multi-pipe is a pipe comprising at least one sub-pipe, as explained above. In this case, section 2 writes to sub-pipes 3.0 and 3.1 (1230, 1240) and section 3 writes to sub-pipes 3.2 and 3.3 (1250, 1260), where the numeral prior to the period indicates the identifier of the multi-pipe (3) and the numeral after the period indicates the identifier of the sub-pipe of the multi-pipe (0 to 3 in this case). A region of a storage unit is allocated to multi-pipe 3, and respective storage elements of the region of the storge unit are dynamically allocated to sub-pipes 3.0 to 3.3. In this example, different sections (sections 2 and 3) thus write to the same underlying physical region of the storage unit, via dynamically allocated sub-pipes.

The directed graph 11 of FIG. 4 also includes sections 4 to 6 (1140 to 1170) and pipes 4 to 6 (1270 to 1290). The sections 4 and 6 (1140, 1160) receive input data from sub-pipes 3.0 and 3.3 (1230, 1260) respectively, and write data to pipes 4 and 6 (1270, 1290) respectively. Section 5 (1150) in FIG. 4 receives a first set of input data via sub-pipe 3.1 (1240) from section 2 (1120) and a second set of input data via sub-pipe 3.2 (1250) from section 3 (1130) and writes data to pipe 5 (1280). Section 7 (1170) of the directed graph 11 receives input data from pipes 4 to 6 (1270 to 1290). Depending on the nature of the operation performed in a particular section and the dependencies of subsequent operations on the output of the operation, any number of input and output pipes may be connected to a particular section in the directed graph.

The directed graph can be represented by a number of sub-graphs each containing a subset of the sections in the graph. FIG. 4 illustrates an arrangement where the graph 11 is broken down into three sub-graphs 1310, 1320, and 1330 which can be connected together to form the complete graph. For example, sub-graph 1310 contains sections 1 and 3 (1110 and 1130) as well as pipe 2 and sub-pipe 3.3 (1220 and 1260)), sub-graph 1320 contains section 2, 4 and 5 (1120, 1140, and 1150) as well as pipe 1 and sub-pipes 3.0 to 3.2 (1210, 1230, 1240, and 1250), and sub-graph 1330 contains sections 6 and 7 (1160 and 1170) as well as pipes 4 to 6 (1270, 1280, and 1290).

The operations performed when executing a neural network can be broken down into a sequence of operations forming a directed graph in the form described in respect of FIG. 4. Examples herein provide more flexibility in execution of a directed graph of operations such as that shown in FIG. 4, and for example allow more complex operations to be executed efficiently. For example, as explained above, a dimension can be decomposed into a multi-dimensional nested loop comprising an inner and an outer dimension, e.g. to optimize usage of available storage. A dimensional combination instruction can then be used to determine a local space dimension range of a local block to be operated on in executing the multi-dimensional nested loop, in accordance with the directed graph of operations.

### Operation Space

When executing progressions of operations, for example structured in a directed graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operators from which a neural network can be composed.

It is desirable to define a set of pre-determined low-level operations from which a broad range of possible higher-level operations that correspond with various machine learning tool sets can be built. One example of such a low-level set of operations, is the Tensor Operator Set Architecture (TOSA). The Tensor Operator Set Architecture (TOSA) provides a set of whole-tensor operations commonly employed by Deep Neural Networks. The intent is to enable a variety of implementations running on a diverse range of processors, with the results at the TOSA level consistent across those implementations. Applications or frameworks which target TOSA can therefore be deployed on a wide range of different processors, including single-instruction multiple-data (SIMD) CPUs, graphics processing units (GPUs) and custom hardware such as neural processing units/tensor processing units (NPUs/TPUs), with defined accuracy and compatibility constraints. Most operators from the common ML frameworks (TensorFlow, PyTorch, etc.) should be expressible in TOSA.

Many of the operations in a defined operation set (such as TOSA) can be represented as a loop of scalar operations. For example, consider a 2D convolution operation which can be expressed as a multi-dimensional loop of scalar operations. These may need to be executed on 2D input data having dimensions input X (IX) and input Y (IY):
(input) Input channel (IC)—a dimension representing the input channels upon which the operation is to be performed (in the example of images this may be three channels each representing one of red, green, and blue input channels)
(input) Kernel dimension X (KX)—a first dimension X of a 2D kernel;
(input) Kernel dimension Y (KY)—a second dimension Y of a 2D kernel;
(output) Output X (OX)—a first dimension of the output feature map for the convolution operation;
(output) Output Y (OY)—a second dimension of the output feature map for the convolution operation;
(output) Batch (N)—a batch dimension of the operation, where the operation is to be batched;
(output) Output channel (OC)—a dimension representing the output channels to be produced for the 2D convolution operation.

In one proposed ordering, KY/KX can be considered the inner-most dimensions and OC is the outer-most dimension.

For the 2D convolution operation example above, it is possible to express the operation to be performed as a “nested for-loop” of scalar operations as is illustrated in the pseudo-code set out below. In practice, when executing this operation, it is necessary for a processor to execute the operation across each of these dimensions by performing a multiple-accumulate operation (MAC), the result of which is then written into an accumulator (e.g. an accumulator buffer in hardware). Having operated through all of these dimensions, the 2D convolution is completed and the contents of the accumulator therefore represents the result of the 2D convolution operation across the entire dimensionality of operation.

```
for(output channel)
  for(batch N)
    for(output Y)
      for(output X)
        for(input channel)
          for(kernel Y)
            for(kernel X)
              MAC
              write accumulator
```

The seven dimensions of the convolution operation can collectively be used to define the ‘operation space’ in which the 2D convolution operation is to be performed. More specifically, the sizes of each dimension can be used to define an effective “bounding box” defining the size, the number of elements in each dimension, of the operation space upon which the operation is to be performed. To illustrate this in more detail, consider an example where a 3×3 (i.e. KX=3; KY=3) convolution operation having padding is to be performed on input data having dimension IX=15; IY=15; N=1; and IC=32. This operation results in the following minimum and maximum index values representing the upper and lower bounds inclusive (i.e. the size) of the dimensionality of the convolution operation as shown in Table 1:

TABLE 1

| | OC | N | OY | OX | IC | KY | KX |
|---|---|---|---|---|---|---|---|
| Min | 0 | 0 | 0 | 0 | 0 | 0 | 0 |
| Max | 63 | 0 | 14 | 14 | 31 | 2 | 2 |

The output of the 2D convolution operation would have dimensions N=1; OY=15; OX=15; OC=64. These values represent the size of the output of the 2D convolution operation but they do not alone wholly represent the size of the operation required to generate that output. To wholly represent the operation space of the operation, all of the dimensions of the operation are required as shown in the above table. A shorthand representation for the dimensions of the 2D convolution operation is [OC N OY OX IC KY KX] and in this specific example can be presented as the minimum and maximum index values as illustrated in the example above i.e. [64 1 15 15 32 33].

Operations such as the 2D convolution operation described above can be separated into operation blocks, each operation block representing a subset of an operation in which each dimension of the operation block covers a subset of the full range of the corresponding dimension in the operation. For example, the 2D convolution described above can be separated into multiple operation blocks by breaking up the operation in the OY, OX, and IC dimensions. With an operation separated into operation blocks, each operation block remains at the same dimension as prior to the separation. For example, breaking up the operation in the OY dimension results in multiple operation blocks in the OY dimension. Breaking the operation into blocks involves separating the operation space of the operation into multiple blocks which each individually represent a portion of the operation but collectively represent the operation space. This block generation involves separating the operation space into blocks representing a non-overlapping subset of the dimensions in the operation space which wholly cover the operation space dimensions (e.g. the set of nested for-loops shown above). In an example where the operation is to be separated into a number of blocks, the operation space is broken down into blocks based upon a predetermined block size which defines for each dimension of the operation a fixed size. This fixed size block may be referred to herein as a block quantum, and may be considered equivalent to the first and second logical block sizes discussed above with reference to FIG. 3, but for a particular dimension prior to decomposition and subsequent dimensional combination (whereas the first and second logical block sizes are for first and second dimensions after a dimension has been decomposed into at least the first and second dimensions).

Alternatively or additionally, a dimension of an operation such as the nested for-loop above, which represents the 2D convolution operation, may be decomposed into a plurality of nested dimensions, which may then be combined using the dimensional combination instruction described herein. For example, the OY dimension may be decomposed into a first dimension and a second dimension, inwards of the first dimension, which may be combined in response to the dimensional combination instruction to map operation blocks in an operation space defined by the multi-dimensional nested loop formed by the first and second dimensions to corresponding local blocks in a local space dimension. This process may be performed for one or more dimensions of an operation such as the 2D convolution operation, to decompose each of the one or more dimensions into a plurality of nested dimensions. Each of the plurality of nested dimensions for a given dimension may be combined with each other, using the dimensional combination instruction as described for the OY dimension.

It will be appreciated therefore that the operation space defines the dimensionality of the operations to be performed when executing a particular operation, and that the dimensionality may be increased by decomposing at least one of the dimensions into a plurality of nested dimensions, and then subsequently reduced by performing the dimensional combination instruction. The above examples are provided in respect of a 2D convolution but the concept is applicable to all types of operation that are to be performed.

### Hardware Implementation

As described above, a data structure in the form of a directed graph may comprise plural sequenced operations that are connected to one another for execution in a progression. Described below is an example hardware arrangement for executing linked operations for at least a portion of a directed graph as illustrated in FIG. 4.

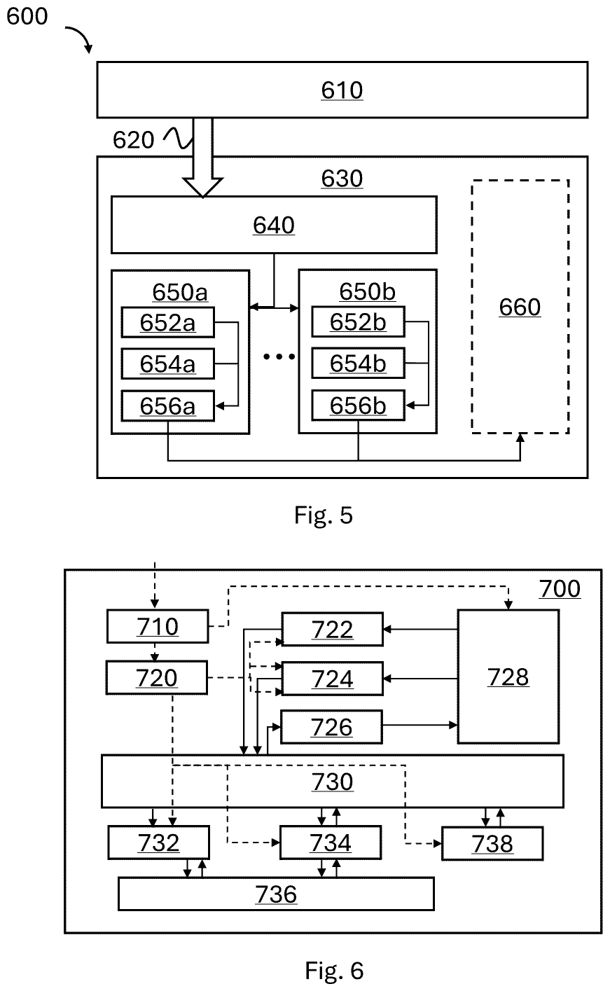

FIG. 5 shows schematically an example of a data processing system 600 including a processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing Units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable to utilize some of the GPU's existing resources (e.g. such that at least some functional units and resources of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor means that the machine learning processing circuit may then be operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 5, the processor 630 is arranged to receive task data 620 from a host processor 610, such as a central processing unit (CPU). The task data comprises at least one command in a given sequence, each command to be executed, and each command may be decomposed into a number of tasks, such as tasks discussed in this disclosure. These tasks may be self-contained operations, such as a given machine learning operation or a graphics processing operation. It will be appreciated that there may be other types of tasks depending on the command.

The task data 620 is sent by the host processor 610 and is received by a command processing unit 640 which is arranged to schedule the commands within the task data 620 in accordance with their sequence. The command processing unit 640 is arranged to schedule the commands and decompose each command in the task data 620 into at least one task. Once the command processing unit 640 has scheduled the commands in the task data 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second tasks may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access to data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the task data 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher-level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBA®) interface, such as the Advanced eXtensible Interface (AXI), may be used.

FIG. 6 is a schematic diagram of a neural engine 700, which in this example is used as a first processing module 652a, 652b in a data processing system 600 in accordance with FIG. 5. The neural engine 700 includes a command and control module 710. The command and control module 710 receives tasks from the command processing unit 640 (shown in FIG. 5), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the directed graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the task data comprises the operation data described with reference to FIGS. 1 to 3 and describes a task to be executed. In this example, the operations are structured as a progression of operations representing a sequence of layers of the neural network. The operations are representable as a directed graph of operations, e.g. as described with reference to FIG. 4, comprising operations connected by connections corresponding to respective logical storage locations, such that a connection associated with an output of an operation of the operations corresponds to a logical storage locations. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 730, a vector engine 732, a transform unit 734, an accumulator buffer 736, and a shared storage 738, for processing of blocks of data. The data dependencies across the functional units are tracked by the handling unit 720. Processing is initiated by the handling unit 720 in a functional unit if all input blocks are available and space is available in the shared storage 738 of the neural engine 700. The shared storage 738 may be considered to be a shared buffer, in that various functional units of the neural engine 700 share access to the shared storage 738.

In the context of a directed graph representing the operations to be performed, each of the internal components that operates upon data can be considered to be one of two types of component. The first type of component is an execution unit (and is identified within the neural engine 700 as such) that maps to a section that performs a specific instance of an operation within the directed graph. The execution unit may be implemented using execution circuitry and may thus be referred to interchangeably as execution circuitry. For example, the weight fetch unit 722, input reader 724, output writer 726, dot product unit array 730, vector engine 732, transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The handling unit 720 is configured to allocate storage elements to respective connections in the directed graph, which can correspond to pipes as explained above. For example, portions of the accumulator buffer 736 and/or portions of the shared storage 738 can each be regarded as a storage element that can act to store data for a pipe or a sub-pipe within the directed graph, as allocated by the handling unit 720. A pipe or a sub-pipe can act as a connection between sections (as executed by execution units) to enable a sequence of operations as defined in the directed graph to be linked together within the neural engine 700. Put another way, the logical dataflow of the directed graph can be mapped to the physical arrangement of execution units and storage elements within the neural engine 700. Under the control of the handling unit 720, execution can be scheduled on the execution units and data can be passed between the execution units via the storage elements in accordance with the mapping, such that the linked operations of a graph can be executed without needing to write data memory external to the neural engine 700 between executions. The handling unit 720 is configured to control and dispatch work representing performing an operation of the graph on at least a portion of the data provided by a pipe or a sub-pipe.

The weight fetch unit 722 fetches weights associated with the neural network from external storage and stores the weights in the shared storage 738. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 730, vector engine 732 and transform unit 734 to generate output data corresponding to an operation in the directed graph. The result of each operation is stored in a specific pipe or sub-pipe within the neural engine 700. The DPU array 730 is arranged to perform one or more operations associated with a dot product operation between two operands, such as between an array of weights and a corresponding block of data (e.g. representing part of a tensor). The vector engine 732 is arranged to perform elementwise operations, for example to apply scale parameters to scale an output of a dot product calculated by the DPU array 730. Data generated during the course of the processing performed by the DPU array 730 and the vector engine 732 may be transmitted for temporary storage in the accumulator buffer 736 from where it may be retrieved by either the DPU array 730 or the vector engine 732 (or another different execution unit) for further processing as desired.

The transform unit 734 is arranged to perform in-block transforms such as dimension broadcasts or axis swaps. The transform unit 734 obtains data (e.g. after processing by the DPU array 730 and/or vector engine 732) from a pipe or a sub-pipe, for example mapped to at least a portion of the shared storage 738 by the handling unit 720. The transform unit 734 writes transformed data back to the shared storage 738.

To make efficient use of the shared storage 738 available within the neural engine 700, the handling unit 720 determines an available portion of the shared storage 738, which is available during execution of part of a first task (e.g. during processing of a block of data associated with the first task by the DPU array 730, vector engine 732 and/or transform unit 734). The handling unit 720 determines a mapping between at least one logical address associated with data generated during execution of a second task (e.g. by processing of a block of data associated with the second task by the DPU array 730, vector engine 732 and/or transform unit 734) and at least one physical address of the shared storage 738 corresponding to the available portion. The logical address is for example a global address in a global coordinate system. Hence, by altering the physical address corresponding to a given logical address, the handling unit 720 can effectively control usage of the shared storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

In an analogous manner, the handling unit 720 can determine a mapping between logical storage locations (e.g. corresponding to respective logical addresses) corresponding to respective connections within the directed graph and sets of storage elements (e.g. corresponding to sets of physical addresses within storage of the neural engine 700, such as within the accumulator buffer 736 and/or the shared storage 738). In this way, the handling unit 720 can for example dynamically allocate first and second sets of storage elements to correspond to first and second logical storage locations associated with first and second operations (e.g. first and second sections) of the directed graph.

The handling unit 720 can for example allocate respective physical storage locations (e.g. corresponding to respective storage elements of the storage of the neural engine 700, such as respective buffers of the accumulator buffer 736 and/or the shared storage 738) for storing respective blocks generated by an operation of the directed graph, such as by a production operation. In allocating the physical storage locations, the handling unit 720 may map logical storage locations (e.g. corresponding to respective logical addresses) corresponding to respective connections within the directed graph to respective sets of storage elements. The mapping may be performed dynamically by the handling unit 720, to utilize the storage of the neural engine 700 more efficiently.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements and/or between sub-pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes and/or sub-pipes.

All storage in the neural engine 700 may be mapped to corresponding pipes and/or sub-pipes, including look-up tables, accumulators, etc., as discussed further below. The width and height of pipes and/or sub-pipes can be programmable, resulting a highly configurable mapping between pipes, sub-pipes and storage elements within the neural engine 700. For example, the handling unit 720 may map a source logical storage location to a source physical storage location of the storage and a destination logical storage location to a destination physical storage location of the storage, with at least one of the source physical storage location and the destination physical storage location corresponding to a connection between an operation to be executed in executing the task described by the task data and a further operation in the directed graph to which the operation is connected. In these examples, the invocation data dispatched by the handling unit 720 to an execution unit may describe at least one of the source or destination physical storage locations, so as to instruct the execution unit to read and/or write data at one of these locations in executing the operation.

Ordering of execution of the sections is implied by dependencies on inputs. A memory load operation has no data dependencies (unless it is a gather operation), so is implicitly early in the graph. The consumer of the pipe (or sub-pipe) that the memory read produces is implicitly after the memory read. A memory store operation is near the end of the graph, as it produces no pipes or sub-pipes for other operations to consume. The sequence of execution of a progression of operations is therefore handled by the handling unit 720.

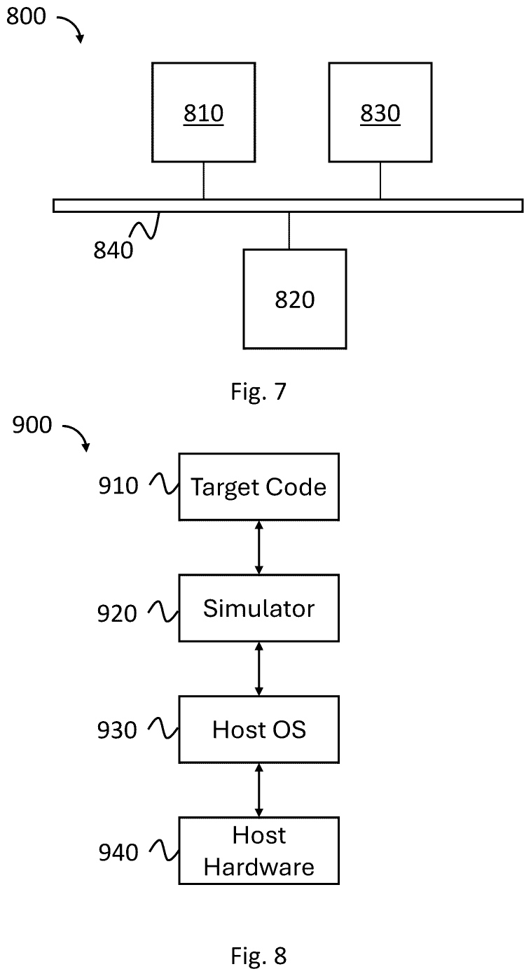

FIG. 7 shows schematically a system 800 for allocating handling data, and in some examples generating a plurality of blocks of input data for processing.

The system 800 comprises host processor 810 such as a central processing unit, or any other type of general processing unit. The host processor 810 issues task data comprising a plurality of commands, each having a plurality of tasks associated therewith.

The system 800 also comprises a processor 830, which may be similar to or the same as the processor 630 of FIG. 5 and may comprise at least some of the components of and/or be configured to perform the methods described above. The processor 830 comprises at least a plurality of compute units 650a, 650b and a command processing unit 640. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBA®) interface, such as the Advanced eXtensible Interface (AXI), may be used.

### Neural Engine Program Descriptor (NED)

As explained above, the neural engine 700 receives tasks from the command processing unit 640 to execute operations from the directed graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of task data processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 is described by task data which in this example is embodied by a neural engine program descriptor (NED), which is a data structure stored in memory and retrieved by the neural engine when executing the task issued by the command processing unit. The NED describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes and/or sub-pipes (graph vertices) and an unordered list of sections/operations (graph nodes). Each operation specifies its input and output giving rise to adjacency of operation in the directed graph to which a particular operation is connected. An example NED comprises a NED structure comprising a header, the elements each corresponding to a section in the graph. The NED describes the various requirements of ordering, number and relationship of these sections and pipes and/or sub-pipes. In one implementation, each of the execution units and each storage element (or portion of a storage element) of the neural engine 700 has a sub-descriptor definition which defines how that execution unit/storage element can be configured for use in implementing a specific section, pipe or sub-pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. A NED may specify which of the queues is assigned so that there remains a 1:1 relationship between what the NED specifies and the physical hardware to which it points.

The dataflow and dependencies of the task's graph is described by pipes and/or sub-pipes. Pipes and/or sub-pipes are used to represent data storage elements within the neural engine 700 and describe the relationship between sections (operations) in a producer-consumer relationship: the output destination pipe or sub-pipe (e.g. a pipe or sub-pipe number) and each input source pipe or sub-pipe (e.g. a pipe or sub-pipe number) for every section is defined in the NED elements of the NED. Pipes and sub-pipes each have only a single producer but may have multiple consumers. A pipe and/or a sub-pipe may be mapped to one of several different physical storage locations (e.g. storage units in the neural engine 700), but not all physical storage locations may be suitable for the different section operations. It will be appreciated that, in some arrangements, a pipe may be mapped to only a portion of a storage unit, which may include at least one storage element. For example, a physical buffer (or a set of physical buffers, which may be or form part of a memory bank) may be considered to be a storage unit, and a physical address (or a set of physical addresses) corresponding to or within a physical buffer may be considered to be a storage element. For example, a storage unit may correspond to a set of physical buffers and a storage element may be a physical buffer of the set of physical buffers, the physical buffer comprising a set of physical addresses. In such cases, a pipe and/or a sub-pipe can describe double-buffering (for example) behavior between its producer and consumers. The output data generated by a section and stored in a pipe or a sub-pipe is referred to equivalently as both a block (of data) and a (virtual) buffer, with a block of data occupying one physical buffer location. Irrespective of location, pipes and/or sub-pipes may be non-coherent with a wider memory system associated with the neural engine 700 and with processor 630, and data is stored out using the Output Writer element of the neural engine 700.

In some arrangements the NED may be configured such that the same pipe is used for multiple inputs, where any relevant usage constraints (such as format or location) are satisfied. For example, an element-wise multiply might have the same pipe for the two input operands in order to square the input. In examples, though, the NED may be configured such that each sub-pipe has a single producer.

In some embodiments, sections such as InputReader and WeightFetcher have no input pipes and/or sub-pipes and instead their data comes from external memory, such as an external cache or DRAM. By contrast, some sections, such as OutputWriter have no output pipes or sub-pipes. In this case, their data is written to external memory.

For a section to run, it must have all the appropriate buffers available for its input source pipes and/or sub-pipes. A section may produce a new buffer in its output destination pipe or sub-pipe and so there must be space available in the pipe or sub-pipe for this new buffer. The neural engine 700 is responsible for tracking all of these dependencies.

The NED is split into multiple data structures that may appear contiguously in memory to be read by the neural engine 700. In this example implementation, the NED header defines the dimensions of the operation space of the operations to be performed. Specifically, the NED header defines the total size of the NED (e.g. number of bytes to be used to represent the NED) as well as a count of the number of section and pipes that are present in the graph.

For each section and pipe in the graph, a count of a corresponding mapped sub-descriptor element types is represented in the NED header. For instance, where the graph (or sub-graph) contains a number of sections, each of those sections is to be executed on a particular compatible execution unit of the neural engine 700. For each section, an element of the appropriate type is therefore counted in the NED header in order to represent the hardware requirements needed to invoke execution of the graph. For example, for a section that defines a convolution operation, a corresponding configuration and invocation of a convolution engine execution unit would be required. Similar counts of instantiations of weight fetch and input read execution units are counted based on the presence of sections that use those operations. This is reflected in the count in the NED header against the weight fetch and input reader elements associated with the weight fetch and input reader units in the neural engine 700.

The NED also contains information that describes any divergent or convergent branches between sections and pipes. For example the NED identifies, for each pipe in the graph, the number of producers and consumers associated with that pipe.

The NED header therefore essentially identifies the operation space and a count of all instances of sections and pipes (for each type of hardware element that is to be allocated for instantiating a section or a pipe that will be required to execute the graph (or sub-graph)) defined by the NED. An illustrative example of at least a portion of the fields stored in the NED header is set out below. In addition to the NED header, the NED further comprises sub-descriptor elements (defining either the configuration of an execution unit or storage element to operate as a section or pipe) for each instance of a section and/or pipe. Each sub-descriptor element defines the configuration of the associated hardware element (either execution unit or storage element) required to execute the section and/or pipe.

An example of at least some of the fields in a NED header is set out below:

| Field | Min | Max |
|---|---|---|
| Operation space size for dimension 1 | — | — |
| Operation space size for dimension 2 | — | — |
| Operation space size for dimension 3 | — | — |
| Operation space size for dimension 4 | — | — |
| Operation space size for dimension 5 | — | — |
| Operation space size for dimension 6 | — | — |
| Operation space size for dimension 7 | — | — |
| Number of weight fetch and decode | 0 | 1 |
| sections | | |
| Number of input reader sections | 1 | 7 |
| Number of output write sections | 1 | 7 |
| Number of convolution engine sections | 0 | 1 |
| Number of transform unit sections | 0 | 7 |
| Number of vector engine sections | 0 | 7 |
| Number of pipes | 1 | 15 |

The theoretical minimum and maximum operation space dimension sizes may be defined at compilation based on the configuration of the neural engine, specifically such that the operations of the task (e.g. sub-graph) can be performed without requiring intermediate data to be stored in a memory element outside of the neural engine. A practical approach to defining a task and its corresponding operation space is set out in more detail later.

The NED header may also comprise pointers to each of the sub-descriptor elements to enable the specific configuration of each element to be read by the handling unit 720.

As mentioned, each instance of the sub-descriptor element defines a configuration of the hardware element (e.g. execution unit or storage element) to which it relates. The following description will provide an example sub-descriptor for a convolution engine.

In an example, the convolution engine is an execution unit which is configured, when invoked, to perform a convolution or pooling operation selected from one or more convolution operations for which the convolution engine is configured. One such example is a 2D convolution operation as described above. In the example of the 2D convolution operation described above, the operation space is 7D—namely [oc, n, oy, ox, ic, ky, kx].

Field

Stride X and Stride Y
Dilation X and Dilation Y
Operation type (e.g. which type of
convolution operation is to be
performed)
Input width and height
Pad Left
Pad Top
Source 0 pipe (input feature map pipe)
Source 1 pipe (weight pipe)
Destination pipe

In this example, the operation type may for example take the form of one of pooling (average or max pooling), 2D convolution, or 2D depth-wise convolution. The source 0 pipe field might identify from which pipe the convolution engine should read the input feature map data—this may for example be a specific portion of a shared buffer. Similarly the source 1 pipe field might indicate from which (different) portion of the shared buffer the weight data is to be retrieved. Finally, the destination pipe might indicate that an accumulation buffer is to act as the pipe for the output of the operation performed by the convolution engine. By identifying for a section specific source and/or destination pipes, which have unique identifiers in the task definition (the NED), any preceding or subsequent sections are implicitly connected and sequenced. Another sub-descriptor element referencing the destination pipe of a different section as a source pipe will inherently read that data and the buffer allocation for that destination pipe may only be released once all of the dependencies have been resolved (e.g. that the sections that rely on that portion of the accumulation buffer have all completed reading that data).

Similar sub-descriptor elements exist for all sections based on configuring the execution units to perform operations. For example, sub-descriptor elements may define destination and source pipes, a pointer to a transform from operation to section space, and a mode of operation for the section.

In this example implementation, pipes represent all storage within the neural engine: all allocation and memory management is handled through a task's NED Pipe definitions and the traversal through the sections that produce and consume these pipes. There is no sharing of pipes between tasks and therefore no architected sharing of data between tasks within the neural engine. A sub-descriptor element is defined in the NED for each pipe in the graph. An example of a pipe sub-descriptor is set out below:

| Field | Min | Max |
|---|---|---|
| Pipe location (e.g. accumulator buffer, | 0 | 2 |
| shared buffer, LUT memory) | | |
| Number of buffers occupied by the pipe | 1 | 16 |
| Starting bank in memory | 1 | 8 |
| Number of banks used by the pipe | 1 | 8 |
| Starting word | 0 | 255 |
| Number of words per buffer | 1 | 256 |

As will be described in more detail later, these descriptors are used to configure the hardware elements when invocation is triggered by the handling unit 720.

### Neural Engine Dimensions and Iteration

In an example, a neural engine task describes a 4D bounding box (dimensions #0-3) that should be operated on by the section operations of a graph defined by a NED that the task provides a pointer to. As well as describing the graph, the NED also defines a further four dimensions (dimensions #4-7), making for a total 8-dimension operation-space. The bounding box for the first four dimensions is a sub-region of the full size of these dimensions, with different tasks and/or jobs covering other sub-regions of these dimensions. As illustrated in FIGS. 4 and 5, the command processing unit 640 may issue different tasks to different neural engines. As such, the dimensions 0-3 when the NED is generated or at the point that the task is defined. The latter four dimensions are described in their entirety in the NED and are therefore covered entirely in each task. The NED additionally defines an increment size for each of these 8 dimensions to be stepped through, known as a block size. Execution of the graph against this 8D operation-space can be considered as a series of nested loops. As explained above with particular reference to FIGS. 1 to 3, at least one of these loops can be decomposed into a plurality of dimensions to form a further multi-dimensional nested loop. The plurality of dimensions can then be combined in response to a dimensional combination instruction to obtain a local space dimension.

Execution of the task's operation-space can thus be split into a series of blocks, with sections being invoked on a block-by-block basis, operating on a block's worth of data in every source and destination pipe. Consequently, defining a general operation space in a coordinate system having for example eight dimensions may provide a low complexity pattern for execution of any task comprising operations on data, instead of relying on fixed functions per task type, which may encompass a significant risk of missing necessary combinations of patterns. By defining a common operation space in a coordinate space, it may be less complex to chain a plurality of operations to be executed on data to each other and coordinate execution of these functions. Operation space dimensions do not have a specific interpretation until they are projected into space for a specific task.

The mapping of operation blocks in the operation space to local blocks in a local space dimension of an operation-specific local space, e.g. in response to the dimensional combination instruction, enables local space dimension ranges of the local blocks in the local space dimension to be obtained. These local space dimension ranges for example correspond to coordinate ranges within the local space dimension of the operation-specific local space, to allow the local blocks to be identified and obtained for use in executing a particular operation.

The number of dimensions in use is dependent on the graph and its operations; not every section will run for increments in each dimension. For example, a convolution operation has a 7D operation-space but only a 4D output space through which the convolution operation increments and accumulates output; a VE scaling operation following a convolution thus only runs for increments in the first four dimensions.

The execution of a neural engine task may be defined by two separate iterative processes implemented in the handling unit. In one process, the handling unit iteratively steps through the task's operation-space in block units as defined by the block size of the NED. In the other process, the handling unit iteratively steps through the dataflow graph defined by the NED and, where permitted by the dimension rules described above, transforms each block into the relevant section space before invoking the section's execution unit with the transformed block by issuing invocation data. In examples herein involving the execution of a dimensional combination instruction, the handling unit performs the latter process, in which execution of the dimensional combination instruction transforms (and combines) operation blocks in a higher-dimensional operation space to local blocks in the local space dimension in the operation-specific local space (which may be considered to correspond to the section space).

In general, for most cases, these two processes are defined in the examples described herein to be architecturally independent. This means that the execution of any given block is defined definitively and completely in itself, in isolation of any other block or the state of the handling unit operation space iteration. The execution of blocks that are not in accordance with this operation space iteration and transformation will run to completion, but the results will not provide meaningful results with respect to full operation definitions of the Tensor Operator Set Architecture (TOSA).

In all cases, execution of a block must not extend beyond the block's section-space boundaries. Loading and storing of data (whether mapping the section-space to coordinates of a tensor in memory, to pipes, or any other memory or pipe storage) may extend beyond the section-space as required by an implementation's granularity of access, but must not extend beyond the size of a pipe's buffer. When the section space is smaller than the pipe buffer, certain reduction operations may have an additional requirement to not modify the data in the buffer beyond the section space but other operations or execution units need not have this requirement.

Iterating over the operation space may generate a block with one or more execution dimensions that are zero and/or (as described with reference to FIG. 3), a block with a low bound that is higher than a high bound, meaning that no functional operation is required. This may occur due to padding before the start of operation space or clipping at the end of operation space, for example. Such a block may nevertheless still be dispatched to the execution unit for correct tracking of dependencies and execution ordering.

### Reduction Operation Example

An example of implementing a reduction operation will now be described. To implement the reduction operation, the handling unit 720 will issue a sequence of block invocations, e.g. in the form of invocation data, to an execution unit (e.g. the convolution engine or vector engine) all targeting the same output block. The invocation data for a particular block specifies the block to be operated on by the execution unit, and for a local block obtained based on dimensional combination as described above may specify a local space dimension range of the local block to be operated on.

The handling unit 720 will signal when executing the first block in this sequence, and the execution unit starts by initializing the destination buffer (which is e.g. the whole buffer as limited by the block's size), whereas for all subsequent blocks in the sequence the execution unit will read back the existing values from the buffer. In this way, the destination buffer acts as an additional input to the operation, from the perspective of individual block execution. In the case of the convolution engine, it is possible that one or more reduction dimensions are zero, meaning that no functional operation is required, but the convolution engine must still initialize the destination buffer if it is the first block in the sequence and the block's execution dimensions aren't empty.

When the handling unit 720 invokes an execution unit to execute a block, the handling unit 720 is configured to issue invocation data to execute the operation on a block. The block iteration is defined based on a block size specified in the NED. Moreover, the handling unit 720 checks that any dependencies that need to be met for the execution unit to operate on the block are satisfied. These include that the required data is stored in the source pipe(s) for the operation and that sufficient storage is available in the destination pipe, as well as that the transform of the operation space to section space for that section has been performed and the output of that transform operation (e.g. the transformed coordinate data, which for example represents the local space dimension range of a local block if the transform comprises dimensional combination as described above) is available to be issued to the execution unit. More specifically, it is to be ensured that there is sufficient availability in the pipe for a new block or buffer. However, this is not needed if this is not the first step in a reduction block, because in this instance the operation may involve simply read-modify-writing a previous destination block/buffer. Determining the availability of a source storage element may involve determining there is an appropriate block/buffer in the source pipe.

In an example, the invocation data comprises the output of the transform program in the form of transformed coordinates along with the relevant parts of the NED that describe that section (e.g. the configuration data from the sub-descriptor element of the NED for that section). This additional configuration data may also include the type of operation being performed (where the execution unit is able to perform more than one type of operation) and any other attributes of the operation, such as stride and dilation values in the example of a convolution operation.

The iteration process first involves reading from the NED a block size and iterating through the operation space one block at a time. For each block, a transform program is executed to transform the operation space coordinates to section space coordinates for that section. The transform program may comprise execution of the dimensional combination instruction if a plurality of dimensions of the operation space are to be combined, so as to combine the plurality of dimensions to obtain a local space dimension in the operation-specific local space (section space). More detail on the transform programs is set out below. Once the section space coordinates (e.g. corresponding to the local space dimension range of a local block obtained by the dimensional combination) have been determined, the section operation is performed in respect of that block. This process is iterated over all blocks until the operation is completed for all blocks.

### Programmability of Operation Space to Section Space Transforms

As discussed above, the operation space for a task (sub-graph) may contain a pre-determined number of dimensions (e.g. eight), at least one of which may be decomposed into a further plurality of dimensions, but the local section space for the operation to be performed for a specific section in that graph can contain fewer than 8 dimensions. Also, as described above, the handling unit may iterate through the operation space in units known as blocks, transforming each block from the common operation space to a section-specific space (referred to herein as the operation-specific local space) described by the various fields in the NED.

In an example implementation, the NED may further comprise for each element in the NED (e.g. each section/pipe) a program comprising transform program data that describes a transform from operation space to section space (local space) for the corresponding section. The transform described by the transform program data may include dimensional combination based on a dimensional combination instruction. Execution of the program may thus cause the dimensional combination to be performed, so as to combine a plurality of dimensions to obtain a local space dimension in an operation-specific local space. The transform program data may further describe the decomposition of a dimension into the plurality of dimensions that are to be combined in response to the dimensional combination instruction (although, in other cases, dimensional combination may be performed without previously decomposing a dimension to obtain the plurality of dimensions that are to be combined).

In one such implementation, each element in the NED may comprise an offset value that points to the specific program within the NED for executing the transform. This offset value may be regarded as a pointer into ‘program space’, being the space in which all the programs which define the various enabled transforms are located. Alternatively, the offset value may be a pointer into a virtual address space in main memory. For example, this program space can be defined in the NED as a field tsu_space_size which for example is sized as 256 bytes. The offset may point to a memory location at which the start of its section-space transform is placed (e.g. the first instruction in a sequence of instructions which collectively define a program for performing the transform).

Each transform program may end with an explicit END instruction, and may be followed without any spacing or alignment by a next program defining a sequence of instructions for executing a different transform that is associated with a different element. Alternatively a starting pointer may be used in conjunction with a total number of instructions to execute.

In an example implementation, the sequence of instructions used for each transform may be selected from a set of pre-determined instructions which effectively form an instruction set. This instruction may be regarded as a transform instruction set which may be a specific set of instructions selected optimally to perform transforms from operation space to section space. Alternatively, the transforms may be general purpose instruction set as seen in a central processing unit (CPU).

In an example implementation, a transform instruction may operate on a set of state values for the transform. The state values comprise boundary registers (in one example eight boundary registers b[0] to b[7]) each comprising a low and a high component, which may be referred to as a low and a high bound, respectively, as explained with reference to FIG. 2. Each block in the operation space is defined by the values described in the low and high components of the eight boundary registers. These values indicate the upper and lower bounds (inclusive) for the coordinates in the block for that axis of the “bounding box” operation space.

In this example, no other state is available to the instructions which operate to transform the operation space to a local section space for a specific operation to be performed. All operations performed by the instructions therefore operate on the boundary registers, including intermediate calculations.

Some sequences of instructions will transform one dimension at a time, starting with dimension 0 (e.g. b[0]) and work iteratively inwards through the dimensions. In other more complex sequences of instructions, more complex transforms may need to jump around by modifying the destination register identifier explicitly e.g. by using a SETD instruction in the set of instructions. An example of a transform program to perform dimensional combination (referred to as a dimensional combination instruction) is described above with reference to FIGS. 1 to 3.

The result of executing the transform program for a specific block defines a block in section space, ready to be used for the invocation of the specific hardware execution unit that is to execute the section. In the case of many types of operation to be performed by a hardware execution unit to execute a section, the execution unit does not use a full 8-dimension section space. The handling unit therefore defines an invocation structure for each unit that defines the relevant requirements for that operation.

### Simulator Implementation

FIG. 8 illustrates a simulator implementation 900 that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 940, optionally running a host operating system 930, supporting the simulator program 920. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware or provide an instruction execution environment typically associated with a different hardware architecture. An overview of simulation is given in “Some Efficient Architecture Simulation Techniques,” Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 940), some simulated embodiments may make use of the host hardware, where suitable.

The simulator program 920 may be stored on a computer-readable storage medium (which may be a non-transitory medium), and provides a program interface (instruction execution environment) to the target code 910 which is the same as the application program interface of the hardware architecture being modelled by the simulator program 920. Thus, the pro. m instructions of the target code 910, including the control of memory accesses based on the realm protection functionality described above, may be executed from within the instruction execution environment using the simulator program 920, so that a host computer 940 which does not actually have the hardware features of the apparatus shown in FIG. 2, discussed above but can emulate these features.

The simulator program 920 is for example a computer program for controlling a host data processing apparatus to provide an instruction execution environment for execution of the target code 910 (which may be referred to as target program code). The simulator program 920 for example comprises data structure program logic for interacting with a data structure and processing program logic configured to implement methods according to examples herein, such as those described with reference to FIGS. 1 to 3.

### Programs and Systems for Implementing Examples Herein

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

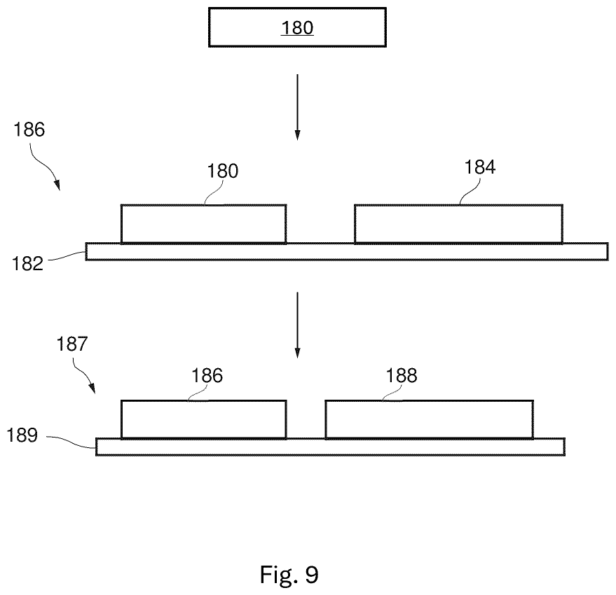

As shown in FIG. 9, one or more packaged chips 180, with the processor described above implemented on one chip or distributed over two or more of the chips, are manufactured by a semiconductor chip manufacturer. In some examples, the chip product 180 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 180 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 180 are assembled on a board 182 together with at least one system component 184 to provide a system 186. For example, the board may comprise a printed circuit board. The board substrate may be made of any of a variety of materials, e.g. plastic, glass, ceramic, or a flexible substrate material such as paper, plastic or textile material. The at least one system component 184 comprise one or more external components which are not part of the one or more packaged chip(s) 180. For example, the at least one system component 184 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 187 is manufactured comprising the system 186 (including the board 182, the one or more chips 180 and the at least one system component 184) and one or more product components 188. The product components 188 comprise one or more further components which are not part of the system 187. As a non-exhaustive list of examples, the one or more product components 188 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 187 and one or more product components 188 may be assembled on to a further board 189.

The board 182 or the further board 189 may be provided on or within a device housing or other structural support (e.g. a frame or blade) to provide a product which can be handled by a user and/or is intended for operational use by a person or company.

The system 186 or the chip-containing product 187 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further Examples

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

Further examples are set out in the following numbered clauses:
1. A processor comprising storage, execution circuitry and a handling unit, the handling unit configured to:
   obtain operation data indicative of an operation to be executed using the execution circuitry, wherein the execution circuitry is configured to operate over a multi-dimensional nested loop defining an operation space;
   obtain a dimensional combination instruction;
   in response to the dimensional combination instruction, combine a plurality of dimensions of the operation space to obtain a local space dimension in an operation-specific local space as part of a procedure to map each operation block of a plurality of operation blocks in the operation space to a different respective local block in the local space dimension; and
   dispatch invocation data for the plurality of operation blocks to the execution circuitry, wherein the invocation data for each respective operation block specifies a local space dimension range of a local block to be operated on for the respective operation block.
2. The processor of clause 1, wherein to combine the plurality of dimensions comprises, for a particular operation block, combining sets of operation block range data, each indicative of a range, in a respective dimension of the plurality of dimensions, of the particular operation block, to generate local block range data indicative of the local space dimension range of the local block to which the particular operation block is mapped.
3. The processor of clause 2, wherein the sets of operation block range data comprise:
   a first set of operation block range data for a first dimension of the plurality of dimensions, the first set of operation block range data representing at least a first low bound and a first high bound of the particular operation block in the first dimension; and
   a second set of operation block range data for a second dimension of the plurality of dimensions, the second set of operation block range data representing at least a second low bound and a second high bound of the particular operation block in the second dimension,
   wherein the local block range data represents a low bound and a high bound of the local block in the local space dimension.
4. The processor of clause 3, wherein the low bound of the local block is based on a combination of the first low bound and the second low bound.
5. The processor of clause 3 or clause 4, wherein the high bound of the local block is based on the first high bound, the second high bound and at least one of the first low bound and the second low bound.
6. The processor of clause 5, wherein:
   in response to the first high bound being smaller than a combination of the second high bound and the first low bound, the high bound of the local block is the first high bound; and
   in response to the first high bound being greater than or equal to a combination of the second high bound and the first low bound, the high bound of the local block is the combination of the second high bound and the first low bound.
7. The processor of any one of clauses 3 to 6, wherein:
   the low bound of the local block is a sum of the first low bound and the second low bound; and
   the high bound of the local block is a minimum of: the first high bound, and a sum of the second high bound and the first low bound.
8. The processor of any one of clauses 2 to 7, wherein to generate the local block range data comprises clipping the range of the local block based on at least one of the sets of operation block range data.
9. The processor of clause 8, when dependent upon any one of clauses 3 to 7, wherein the first high bound is higher than the second high bound, and the clipping comprises clipping the high bound of the local block to the first high bound.
10. The processor of clause 8, when dependent upon any one of clauses 3 to 7, or clause 9, wherein, after the clipping, the high bound of the local block is lower than the low bound of the local block.
11. The processor of clause 10, wherein the invocation data instructs execution of at least part of the operation by the execution circuitry, and, in response to the high bound of the local block being lower than the low bound of the local block, the handling unit is configured to generate the invocation data to indicate a physical storage location of the storage storing predefined data for the local block indicative that processing of the local block, in executing the at least part of the operation, is to be omitted.
12. The processor of clause 11, wherein the execution circuitry is configured to:
   based on the invocation data, obtain the predefined data from the physical storage location;
   based on the predefined data, refrain from processing the local block in executing the at least part of the operation.
13. The processor of any one of clauses 1 to 12, wherein the operation space is defined by data stored in boundary registers and to combine the plurality of dimensions comprises, for a particular operation block, combining first data stored in a first boundary register, associated with a first dimension of the plurality of dimensions, with second data stored in a second boundary register, associated with a second dimension of the plurality of dimensions, to generate transformed data in at least one of the boundary registers, the transformed data defining a local block to which the particular operation block is mapped.
14. The processor of any one of clauses 1 to 13, wherein the plurality of dimensions comprise a first dimension corresponding to a first loop of the multi-dimensional nested loop and a second dimension corresponding to a second loop of the multi-dimensional nested loop, inwards of the first loop, and the plurality of operation blocks comprises a plurality of sets of operation blocks, each corresponding to a different iteration of the first loop, and, for each respective set of the plurality of sets of operation blocks, each operation block of the respective set corresponds to a different iteration of the second loop.
15. The processor of any one of clauses 1 to 14, wherein, based on the operation data, the handling unit is configured to:
   determine a first logical block size for a first dimension of the plurality of dimensions;
   divide the first dimension into a first set of one-dimensional blocks based on the first logical block size, the first logical block size corresponding to a first physical block size;
   determine a second logical block size for a second dimension of the plurality of dimensions; and
   divide the second dimension into a second set of one-dimensional blocks based on the second logical block size, the second logical block size corresponding to a second physical block size,
   wherein a size of the storage is less than n times the first physical block size and greater than or equal to n times the second physical block size, wherein n is an integer with a value greater than or equal to 2.
16. The processor of clause 15, when dependent upon clause 14, wherein each block of the first set of one-dimensional blocks corresponds to a respective iteration of the first loop, each block of the second set of one-dimensional blocks corresponds to a respective iteration of the second loop, an iteration of the first loop comprises m iterations of the second loop, wherein m is an integer, and wherein the size of the storage is less than twice the first physical block size and greater than or equal to m times the second physical block size.
17. The processor of any one of clauses 1 to 16, wherein the handling unit is configured to obtain task data comprising the operation data, the task data describing a task to be executed, the task comprising a plurality of operations representable as a directed graph of operations comprising operations connected by connections corresponding to respective logical storage locations, such that a connection associated with an output of an operation of the operations corresponds to a logical storage locations.
18. The processor of clause 17, wherein the invocation data further describes at least one of:
   a source physical storage location of the storage, corresponding to a source logical storage location; and
   a destination physical storage location of the storage, corresponding to a destination logical storage location,
   the at least one of the source physical storage location and the destination physical storage location corresponding to a connection between the operation and a further operation in the directed graph to which the operation is connected.
19. A computer program for controlling a host data processing apparatus to provide an instruction execution environment for execution of target program code, the computer program comprising:
   data structure program logic for interacting with a data structure; and
   processing program logic configured to:
      obtain operation data indicative of an operation to be executed using the processing program logic, the processing program logic configured to operate over a multi-dimensional nested loop defining an operation space;
      obtain a dimensional combination instruction;
      in response to the dimensional combination instruction, combine a plurality of dimensions of the operation space to obtain a local space dimension in an operation-specific local space as part of a procedure to map each operation block of a plurality of operation blocks in the operation space to a different respective local block in the local space dimension; and
      provide invocation data for the plurality of operation blocks to the data structure program logic, wherein the invocation data for each respective operation block specifies a local space dimension range of a local block to be operated on for the respective operation block.
20. The computer program of clause 19, wherein to combine the plurality of dimensions comprises, for a particular operation block, combining sets of operation block range data, each indicative of a range, in a respective dimension of the plurality of dimensions, of the particular operation block, to generate local block range data indicative of the local space dimension range of the local block to which the particular operation block is mapped.
21. The computer program of clause 20, wherein to generate the local block range data comprises clipping the range of the local block based on at least one of the sets of operation block range data.
22. A method of performing a dimensional combination instruction, the method comprising:
   obtaining, by handling circuitry, operation data indicative of an operation to be executed using processing circuitry, wherein the processing circuitry is configured to operate over a multi-dimensional nested loop defining an operation space;
   obtaining, by the handling circuitry, the dimensional combination instruction;
   in response to the dimensional combination instruction, the handling circuitry combining a plurality of dimensions of the operation space to obtain a local space dimension in an operation-specific local space, such that each operation block of a plurality of operation blocks in the operation space is mapped to a different respective local block in the local space dimension.
23. The method of clause 22, comprising generating invocation data for the plurality of operation blocks, for dispatching to execution circuitry, wherein the invocation data for each respective operation block specifies a local space dimension range of a local block to be operated on for the respective operation block.
24. The method of clause 23, wherein to combine the plurality of dimensions comprises, for a particular operation block, combining sets of operation block range data, each indicative of a range, in a respective dimension of the plurality of dimensions, of the particular operation block, to generate local block range data indicative of the local space dimension range of the local block to which the particular operation block is mapped.
25. The method of clause 24, wherein to generate the local block range data comprises clipping the range of the local block based on at least one of the sets of operation block range data.

What is claimed is:

1. A processor comprising storage, execution circuitry and a handling unit, the handling unit configured to:
obtain operation data indicative of an operation to be executed using the execution circuitry, wherein the execution circuitry is configured to operate over a multi-dimensional nested loop defining an operation space;
obtain a dimensional combination instruction;
in response to the dimensional combination instruction, combine a plurality of dimensions of the operation space to obtain a local space dimension in an operation-specific local space as part of a procedure to map each operation block of a plurality of operation blocks in the operation space to a different respective local block in the local space dimension; and
dispatch invocation data for the plurality of operation blocks to the execution circuitry, wherein the invocation data for each respective operation block specifies a local space dimension range of a local block to be operated on for the respective operation block.

2. The processor of claim 1, wherein to combine the plurality of dimensions comprises, for a particular operation block, combining sets of operation block range data, each indicative of a range, in a respective dimension of the plurality of dimensions, of the particular operation block, to generate local block range data indicative of the local space dimension range of the local block to which the particular operation block is mapped.

3. The processor of claim 2, wherein the sets of operation block range data comprise:
a first set of operation block range data for a first dimension of the plurality of dimensions, the first set of operation block range data representing at least a first low bound and a first high bound of the particular operation block in the first dimension; and
a second set of operation block range data for a second dimension of the plurality of dimensions, the second set of operation block range data representing at least a second low bound and a second high bound of the particular operation block in the second dimension,
wherein the local block range data represents a low bound and a high bound of the local block in the local space dimension.

4. The processor of claim 3, wherein at least one of:
the low bound of the local block is based on a combination of the first low bound and the second low bound; or
the high bound of the local block is based on the first high bound, the second high bound and at least one of the first low bound and the second low bound; or
in response to the first high bound being smaller than a combination of the second high bound and the first low bound, the high bound of the local block is the first high bound and, in response to the first high bound being greater than or equal to a combination of the second high bound and the first low bound, the high bound of the local block is the combination of the second high bound and the first low bound.

5. The processor of claim 3, wherein:
the low bound of the local block is a sum of the first low bound and the second low bound; and
the high bound of the local block is a minimum of: the first high bound, and a sum of the second high bound and the first low bound.

6. The processor of claim 2, wherein to generate the local block range data comprises clipping the range of the local block based on at least one of the sets of operation block range data.

7. The processor of claim 6, wherein the sets of operation block range data comprise:
a first set of operation block range data for a first dimension of the plurality of dimensions, the first set of operation block range data representing at least a first low bound and a first high bound of the particular operation block in the first dimension; and
a second set of operation block range data for a second dimension of the plurality of dimensions, the second set of operation block range data representing at least a second low bound and a second high bound of the particular operation block in the second dimension,
wherein the local block range data represents a low bound and a high bound of the local block in the local space dimension, the first high bound is higher than the second high bound, and the clipping comprises clipping the high bound of the local block to the first high bound.

8. The processor of claim 7, wherein, after the clipping, the high bound of the local block is lower than the low bound of the local block.

9. The processor of claim 8, wherein the invocation data instructs execution of at least part of the operation by the execution circuitry, and, in response to the high bound of the local block being lower than the low bound of the local block, the handling unit is configured to generate the invocation data to indicate a physical storage location of the storage storing predefined data for the local block indicative that processing of the local block, in executing the at least part of the operation, is to be omitted.

10. The processor of claim 9, wherein the execution circuitry is configured to:
based on the invocation data, obtain the predefined data from the physical storage location;
based on the predefined data, refrain from processing the local block in executing the at least part of the operation.

11. The processor of claim 1, wherein the operation space is defined by data stored in boundary registers and to combine the plurality of dimensions comprises, for a particular operation block, combining first data stored in a first boundary register, associated with a first dimension of the plurality of dimensions, with second data stored in a second boundary register, associated with a second dimension of the plurality of dimensions, to generate transformed data in at least one of the boundary registers, the transformed data defining a local block to which the particular operation block is mapped.

12. The processor of claim 1, wherein the plurality of dimensions comprise a first dimension corresponding to a first loop of the multi-dimensional nested loop and a second dimension corresponding to a second loop of the multi-dimensional nested loop, inwards of the first loop, and the plurality of operation blocks comprises a plurality of sets of operation blocks, each corresponding to a different iteration of the first loop, and, for each respective set of the plurality of sets of operation blocks, each operation block of the respective set corresponds to a different iteration of the second loop.

13. The processor of claim 1, wherein, based on the operation data, the handling unit is configured to:
determine a first logical block size for a first dimension of the plurality of dimensions;
divide the first dimension into a first set of one-dimensional blocks based on the first logical block size, the first logical block size corresponding to a first physical block size;
determine a second logical block size for a second dimension of the plurality of dimensions; and
divide the second dimension into a second set of one-dimensional blocks based on the second logical block size, the second logical block size corresponding to a second physical block size,
wherein a size of the storage is less than n times the first physical block size and greater than or equal to n times the second physical block size, wherein n is an integer with a value greater than or equal to 2.

14. The processor of claim 13, wherein the plurality of dimensions comprise a first dimension corresponding to a first loop of the multi-dimensional nested loop and a second dimension corresponding to a second loop of the multi-dimensional nested loop, inwards of the first loop, and the plurality of operation blocks comprises a plurality of sets of operation blocks, each corresponding to a different iteration of the first loop, and, for each respective set of the plurality of sets of operation blocks, each operation block of the respective set corresponds to a different iteration of the second loop, and wherein each block of the first set of one-dimensional blocks corresponds to a respective iteration of the first loop, each block of the second set of one-dimensional blocks corresponds to a respective iteration of the second loop, an iteration of the first loop comprises m iterations of the second loop, wherein m is an integer, and wherein the size of the storage is less than m times the first physical block size and greater than or equal to m times the second physical block size.

15. The processor of claim 1, wherein the handling unit is configured to obtain task data comprising the operation data, the task data describing a task to be executed, the task comprising a plurality of operations representable as a directed graph of operations comprising operations connected by connections corresponding to respective logical storage locations, such that a connection associated with an output of an operation of the operations corresponds to a logical storage locations, wherein optionally the invocation data further describes at least one of:
a source physical storage location of the storage, corresponding to a source logical storage location; and
a destination physical storage location of the storage, corresponding to a destination logical storage location,
the at least one of the source physical storage location and the destination physical storage location corresponding to a connection between the operation and a further operation in the directed graph to which the operation is connected.

16. A computer program for controlling a host data processing apparatus to provide an instruction execution environment for execution of target program code, the computer program comprising:
data structure program logic for interacting with a data structure; and
processing program logic configured to:
obtain operation data indicative of an operation to be executed using the processing program logic, the processing program logic configured to operate over a multi-dimensional nested loop defining an operation space;
obtain a dimensional combination instruction;
in response to the dimensional combination instruction, combine a plurality of dimensions of the operation space to obtain a local space dimension in an operation-specific local space as part of a procedure to map each operation block of a plurality of operation blocks in the operation space to a different respective local block in the local space dimension; and
provide invocation data for the plurality of operation blocks to the data structure program logic, wherein the invocation data for each respective operation block specifies a local space dimension range of a local block to be operated on for the respective operation block.

17. The computer program of claim 16, wherein to combine the plurality of dimensions comprises, for a particular operation block, combining sets of operation block range data, each indicative of a range, in a respective dimension of the plurality of dimensions, of the particular operation block, to generate local block range data indicative of the local space dimension range of the local block to which the particular operation block is mapped, wherein optionally to generate the local block range data comprises clipping the range of the local block based on at least one of the sets of operation block range data.

18. A method of performing a dimensional combination instruction, the method comprising:
obtaining, by handling circuitry, operation data indicative of an operation to be executed using processing circuitry, wherein the processing circuitry is configured to operate over a multi-dimensional nested loop defining an operation space;
obtaining, by the handling circuitry, the dimensional combination instruction;
in response to the dimensional combination instruction, the handling circuitry combining a plurality of dimensions of the operation space to obtain a local space dimension in an operation-specific local space, such that each operation block of a plurality of operation blocks in the operation space is mapped to a different respective local block in the local space dimension.

19. The method of claim 18, comprising generating invocation data for the plurality of operation blocks, for dispatching to execution circuitry, wherein the invocation data for each respective operation block specifies a local space dimension range of a local block to be operated on for the respective operation block.

20. The method of claim 19, wherein to combine the plurality of dimensions comprises, for a particular operation block, combining sets of operation block range data, each indicative of a range, in a respective dimension of the plurality of dimensions, of the particular operation block, to generate local block range data indicative of the local space dimension range of the local block to which the particular operation block is mapped, wherein optionally to generate the local block range data comprises clipping the range of the local block based on at least one of the sets of operation block range data.
